(19) United States
(12) Patent Application Publication
(10) Pub. No.: US 2011/0244275 A1
(43) Pub. Date: Oct. 6, 2011

(54) BATTERY

(75) Inventors: Helmut Brantsch, Ingolstadt (DE); Franz Hillenmayer, Burglengenfeld (DE)

(73) Assignee: CONTINENTAL AUTOMOTIVE GMBH, Hannover (DE)

(21) Appl. No.: 13/133,253

(22) PCT Filed: Nov. 23, 2009
(86) PCT No.: PCT/EP2009/065653

§ 371 Date: Jun. 7, 2011

(30) Foreign Application Priority Data
Dec. 11, 2008 (DE) 10 2008 061 584.6

(51) Int. Cl. H01M 10/42; G01M 17/02

(52) U.S. Cl. 429/7; 73/146

(57) ABSTRACT

A battery has an at least partially electrically conducting housing, a first charge carrier, a second charge carrier, and a battery cover. The battery cover encompasses a printed circuit board that has a first circuit board contact and a second circuit board contact. The circuit board contacts are electrically connected to the charge carriers.

The invention relates to a battery and to a tire pressure measurement system.

Battery-powered electrical circuits comprise an electronic unit and a battery. Battery conductors and battery holders may also be provided in this case. In the case of battery-powered tire pressure measurement systems, a housing and a fastening means may additionally be required in the tire. The centrifugal forces acting on electronic modules provided on one side in or on the tire during travel act on the tire on one side and thus influence the rotational behavior of the tire. The centrifugal forces increase with the speed of the vehicle and affect the rotational behavior of the tire, in particular as the weight of the electronic modules increases.

In the case of correspondingly high weights, the centrifugal forces in the rotating wheel may result in the tire no longer rolling uniformly, which can also be perceived as disruptive by the driver.

Therefore, the present invention is based on the object of providing a battery and a tire pressure measurement system, which battery has a low weight.

According to the invention, this object is achieved by a battery having the features of claim 1 and a tire pressure measurement system according to claim 12. The dependent claims relate to advantageous embodiments and developments which can be used individually or in combination with one another.

In a first aspect, the invention relates to a battery comprising an at least partially electrically conductive housing, a first charge carrier, a second charge carrier and a battery cover, the battery cover comprising a printed circuit board having a first printed circuit board contact and a second printed circuit board contact, the printed circuit board contacts being electrically connected to the charge carriers. This makes it possible to supply the printed circuit board with energy in a simple, space-saving and weight-saving manner by means of the charge carriers. In comparison with a battery which supplies an electronic unit comprising a plurality of components—in particular standard components—with electrical energy, the battery according to the invention makes it possible to substantially reduce weight. In particular, in the case of a battery for operating a tire pressure measurement system having electronic modules which are arranged on or in the tire, said system may have as little weight as possible as a result. Provided with corresponding electrical insulation means, the housing may also be completely electrically conductive, in particular may be made of electrically conductive metal.

In one preferred refinement, one of the printed circuit board contacts and one of the charge carriers are arranged in such a manner that the one of the printed circuit board contacts and the one of the charge carriers are electrically connected by means of contact.

In another preferred refinement, the connection between the printed circuit board and the at least partially electrically conductive housing has an adhesive which simultaneously acts as a seal.

In another preferred refinement, a separating element is arranged between the first charge carrier and the second charge carrier in order to electrically separate the charge carriers.

In another preferred refinement of the invention, the printed circuit board has conductor tracks having a material which is resistant to the chemical substances, for example manganese oxide and lithium, of the battery. The resistant material expediently comprises gold.

In another preferred refinement, the printed circuit board has a printed circuit board gap which is coated with a moisture barrier. The printed circuit board contacts are electrically insulated from one another by the printed circuit board gap. The moisture barrier advantageously prevents moisture from entering the battery from the outside. The moisture barrier is achieved, for example, by means of a corresponding varnish.

In another preferred refinement, the printed circuit board comprises electronic components. In this case, one of the electronic components is in the form of an antenna.

In another preferred refinement, the printed circuit board comprises a plurality of printed circuit board layers which are electrically connected to one another.

In another preferred refinement, the printed circuit board comprises sensors for measuring tire characteristic data and transmitting and/or receiving means for transmitting and/or receiving information. As a result, the measured tire characteristic data can be transmitted to an evaluation unit in the vehicle, for example. Furthermore, the receiving means may use, for example, external trigger signals to trigger the transmission of pressure and/or information.

In a second aspect, the invention relates to a tire pressure measurement system having at least one sensor for measuring tire characteristic data, transmitting and/or receiving means for transmitting and/or receiving information and having a battery which comprises a battery cover which is at least partially in the form of a printed circuit board, the at least one sensor and/or the transmitting and/or receiving means being arranged on the printed circuit board. This makes it possible to reduce the weight in comparison with a tire pressure measurement system having sensors and transmitting and/or receiving means which are separate from the battery.

Further details and advantages of the invention are explained with reference to the accompanying figure, in which:

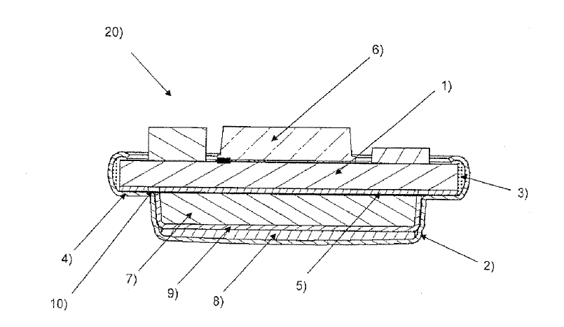

FIG. 1 schematically shows a battery 20. The battery 20 comprises an electrically conductive housing 2 in which a first charge carrier 7 and a second charge carrier 8 of the battery 20 are arranged. The first charge carrier 7 and the second charge carrier 8 are separated by a separating element 9 which electrically separates the charge carriers from one another. The battery cover is in the form of a printed circuit board 1 having a first printed circuit board contact 4 and a second printed circuit board contact 5. The printed circuit board 1 is connected to the electrically conductive housing 2 by means of an adhesive bond 3 which also acts as a seal. The printed circuit board 1 also has conductor tracks and a printed circuit board gap 10 which constitutes electrical insulation between the printed circuit board contacts 4 and 5.

The printed circuit board contacts 4, 5 are electrically connected to the charge carriers 7, 8 such that the printed circuit board 1 is supplied with energy by the charge carriers 7, 8. In one preferred embodiment, one of the printed circuit board contacts 4, 5 and one of the charge carriers 7, 8 are arranged in such a manner that the one of the printed circuit board contacts 4, 5 and the one of the charge carriers 7, 8 are electrically connected by means of contact. In this case, the second charge carrier 8 is electrically connected to the second printed circuit board contact 4 via the electrically conductive housing 2.

The printed circuit board 1 has a top side and an underside, the top side pointing outward in relation to the battery 20 and the underside pointing inward. In this case, the conductor tracks may be arranged both on the top side and on the underside of the printed circuit board 1. At least one of the printed circuit board contacts 4, 5 is arranged on the underside of the printed circuit board 1 such that a direct electrical connection to one of the charge carriers 7, 8 can be established by means of contact. The electrical components 6 are arranged on the top side of the printed circuit board 1.

As a result of the battery 20 according to the invention, there is no need for any additional lines for connecting the printed circuit board contacts 4, 5 to the charge carriers 7, 8. Furthermore, the printed circuit board 1 replaces the conventional cover of the battery 20, thus saving weight. Furthermore, electronic components 6 may be arranged on the printed circuit board 1, for example sensors for measuring physical variables, evaluation electronics and transmitting and/or receiving units such as antennas.

The printed circuit board 1 may be configured in such a manner that it forms complete wheel electronics for measuring and transmitting tire characteristic data, the charge carriers 7, 8 supplying the printed circuit board with power or energy.

The present invention is particularly suitable for batteries for tire pressure control systems.

1-12. (canceled)

13. A battery, comprising:
an at least partially electrically conductive housing;
a first charge carrier and a second charge carrier disposed in said housing;
a battery cover formed, at least in part, of a printed circuit board, said printed circuit board having a first printed circuit board contact and a second printed circuit board contact, said first and second printed circuit board contacts being electrically connected to said first and second charge carriers.

14. The battery according to claim 13, wherein one of said printed circuit board contacts and one of said charge carriers are disposed such that the one of said printed circuit board contacts and said one of said charge carriers are in contact with one another for establishing an electrical connection.

15. The battery according to claim 13, which comprises an adhesive connecting said printed circuit board and said housing and forming a seal therebetween.

16. The battery according to claim 13, which comprises a separating element disposed between said first charge carrier and said second charge carrier.

17. The battery according to claim 13, wherein said printed circuit board is formed with conductor tracks having a material that is resistant to chemical elements of the battery.

18. The battery according to claim 17, wherein said material of said conductor tracks contains gold.

19. The battery according to claim 17, wherein said material of said conductor tracks is gold.

20. The battery according to claim 13, wherein said printed circuit board comprises a printed circuit board gap that is coated with a moisture barrier.

21. The battery according to claim 13, wherein said printed circuit board comprises electronic components.

22. The battery according to claim 21, wherein one of said electronic components is an antenna.

23. The battery according to claim 13, wherein said printed circuit board comprises a plurality of electrically interconnected printed circuit board layers.

24. The battery according to claim 13, wherein said printed circuit board comprises sensors for measuring tire characteristic data and communication devices for transmitting and/or receiving information.

25. A tire pressure measurement system, comprising:
a battery according to claim 13 and having a battery cover at least partially formed of a printed circuit board;
at least one sensor for measuring tire characteristic data mounted on said printed circuit board;
transmitting and/or receiving devices for transmitting and/or receiving information mounted on said printed circuit board.
